(19) United States
(12) Patent Application Publication
(10) Pub. No.: US 2025/0291149 A1
(43) Pub. Date: Sep. 18, 2025

(54) LENS DEVICE

(71) Applicant: FUJIFILM Corporation, Tokyo (JP)

(72) Inventor: Tsuyoshi MITARAI, Saitama-shi (JP)

(73) Assignee: FUJIFILM Corporation, Tokyo (JP)

(21) Appl. No.: 19/076,963

(22) Filed: Mar. 11, 2025

(30) Foreign Application Priority Data
Mar. 13, 2024 (JP) 2024-038598

(51) Int. Cl. G02B 7/04

(52) U.S. Cl. CPC G02B 7/04

(57) ABSTRACT

The lens device includes a lens portion, an operation ring that has a first gear portion and a second gear portion and that operates movement of the lens portion, and a fixing member that is fixed to the lens barrel and that supports movement of the lens portion in an optical axis direction. The fixing member and the operation ring are relatively moved while sliding on each other, and a sliding portion slides on the convex portion formed on at least any one of the fixing member or the operation ring.

### CROSS-REFERENCE TO RELATED APPLICATIONS

This application claims priority under 35 U.S.C § 119 (a) to Japanese Patent Application No. 2024-038598 filed on 13 Mar. 2024. The above application is hereby expressly incorporated by reference, in its entirety, into the present application.

### BACKGROUND OF THE INVENTION

### 1. Field of the Invention

The present invention relates to a lens device.

### 2. Description of the Related Art

JP2018-77363A discloses a lens barrel including a fixed lens barrel having an optical element group, and a first operation ring that is provided on an outer periphery of the fixed lens barrel and is rotated in a rotation direction around the optical axis to operate the lens barrel, further including a second operation ring that rotates in conjunction with the first operation ring, and a friction member that is provided on the first operation ring and generates a frictional force that is a resistance force during rotation of the first operation ring by sliding with the fixed barrel, in which the frictional force generated between the friction member and the fixed lens barrel is changed by changing an amount of deviation of a relative rotation direction position between the first operation ring and the second operation ring. In a case where the driving unit for external connection is used, it is possible to achieve both suppression of a load during electric drive in the driving unit and generation of an operation load during a manual operation.

JP2000-321479A discloses an imaging device for imaging by switching the driving of an optical lens between manual driving and electric driving, the imaging device including a rotating member that is rotatable during driving of the optical lens, a fixing member that is positioned outside the optical lens, a sliding torque generating member that comes into contact with both the rotating member and the fixing member, and a switching mechanism that switches a drive transmission system in accordance with switching between the manual driving and the electric driving, in which the switching mechanism switches between sliding a first sliding surface between the sliding torque generating member and the rotating member without rotating the sliding torque generating member together with the rotating member, and sliding a second sliding surface between the first sliding surface between the sliding torque generating member and the fixing member and the sliding torque by rotating the sliding torque generating member together with the rotating member. The load of the operation torque in a case of manual driving and the load of the operation torque in a case of electric driving are set separately, and the operation torque in a case of manual driving is set to be higher than the operation torque in a case of electric driving.

JP6204761B (corresponding to US2015/062423A1) discloses a lens device including a movable optical member, an operation ring that is disposed on an outer periphery of a lens barrel and drives the movable optical member by a rotation operation around an optical axis, and an electric operation unit for electrically driving the operation ring, in which the operation ring is formed on an outer peripheral surface around the optical axis and has a plurality of gears separated from each other in the optical axis direction, and the plurality of gears are configured on different members, the plurality of gears are always integrally rotated around the optical axis during operation, the gear of the electric operation unit is engaged with one of the plurality of gears, and the other gear of the plurality of gears is disposed at a position where the other gear does not interfere with the electric operation unit in the optical axis direction. In the lens device including an electric operation unit, even in a case where an external rotation operation accessory is mounted, the operation of other operation rings is not impaired, and various rotation operation accessories having different gear specifications from the electric operation unit can be supported.

### SUMMARY OF THE INVENTION

Provided is a lens device in which, in a case where an operation ring is driven from the outside, a sliding surface is not subjected to an excessive force even in a case where any one of a first gear portion and a second gear portion provided in the operation ring is used.

According to an aspect of the present disclosure, there is a lens device comprising: a lens portion; an operation ring that has a first gear portion and a second gear portion and that operates movement of the lens portion; a fixing member that is fixed to a lens barrel and that supports movement of the lens portion in an optical axis direction, in which the fixing member and the operation ring are relatively moved while sliding on each other; and a sliding portion slides on a convex portion formed on at least any one of the fixing member or the operation ring.

In addition, it is preferable that the operation ring includes a first operation ring that has the first gear portion, a second operation ring that has the second gear portion, and a connecting member that connects the first operation ring and the second operation ring and converts rotation of the first operation ring and the second operation ring into the movement of the lens portion in the optical axis direction, and the sliding portion slides on the convex portion formed on at least any one of the fixing member or the connecting member.

In addition, it is preferable that the fixing member includes a guide groove that guides the movement of the lens portion by suppressing rotation of the lens portion with rotation of the operation ring.

In addition, it is preferable that the sliding portion includes a first sliding portion and a second sliding portion, as viewed in a direction intersecting an optical axis of the lens portion, the first sliding portion is disposed in a region from a position facing the first gear portion toward a subject side, and the second sliding portion is disposed in a region from a position facing the second gear portion toward an image forming side.

In addition, it is preferable that the sliding portion includes a first sliding portion and a second sliding portion, and the first sliding portion and the second sliding portion are disposed such that a first reaction force in the first sliding portion and a second reaction force in the second sliding portion, which are generated in a case where an external force is applied to at least any one of the first gear portion or the second gear portion, are in the same direction.

In addition, it is preferable that, as viewed in the direction intersecting the optical axis of the lens portion, the first sliding portion is disposed closer to the subject side than the first gear portion, and the second sliding portion is disposed to have an overlapping region with the second gear portion.

In addition, it is preferable that a first module of the first gear portion and a second module of the second gear portion have different sizes.

In addition, it is preferable that the first module is larger than the second module.

In addition, it is preferable that as viewed in a direction intersecting an optical axis, the first gear portion is disposed inside the guide groove.

In addition, it is preferable that the first gear portion and the second gear portion are formed in a circumferential direction of the operation ring, the first gear portion has a larger diameter than the second gear portion, and the first sliding portion has a smaller width than the second sliding portion.

According to the present invention, in a case where the operation ring is driven from the outside, a sliding surface is not subjected to an excessive force even in a case where any one of the first gear portion or the second gear portion provided in the operation ring is used, and a smooth movement is obtained.

### BRIEF DESCRIPTION OF THE DRAWINGS

FIG. 1 is a plan view of a lens device.

FIG. 2 is a perspective view of the lens device.

FIG. 3 is a cross-sectional view of the lens device taken along line III-III of FIG. 1.

FIG. 4 is a cross-sectional view showing a state in which a fixing member is fixed to a lens barrel.

FIG. 5 is a perspective view of a fixing member.

FIG. 6 is a perspective view of a first lens portion.

FIG. 7 is a perspective view of a second lens portion.

FIG. 8 is a perspective view of a connecting member of an operation ring.

FIG. 9 is a perspective view of a state in which a first lens portion and a second lens portion are assembled to the connecting member of the operation ring.

FIG. 10 is a perspective view of a first operation ring of the operation ring.

FIG. 11 is a perspective view of a second operation ring of the operation ring.

FIG. 12 is a cross-sectional view showing a first cam follower portion and a second cam follower portion.

FIG. 13 is a diagram for describing a positional relationship between a gear portion and a sliding portion.

FIG. 14 is a diagram for describing a positional relationship between a gear portion and a sliding portion.

FIG. 15 is a cross-sectional view showing an angle restricting member.

### DESCRIPTION OF THE PREFERRED EMBODIMENTS

### First Embodiment

### Configuration of Camera

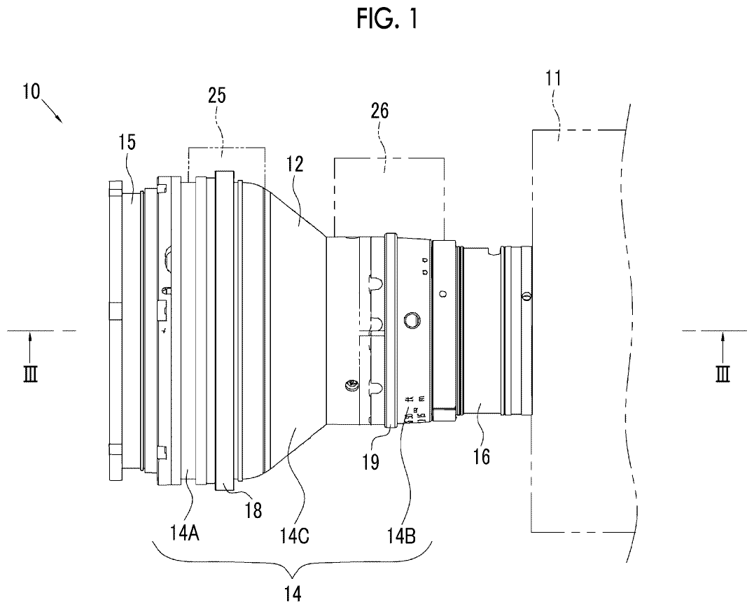

As shown in FIG. 1, a camera 10 comprises a camera body 11 and an interchangeable lens device 12. The lens device 12 is attachably and detachably mounted on a lens mount (not shown) on a front surface of the camera body 11.

### Configuration of Lens Device

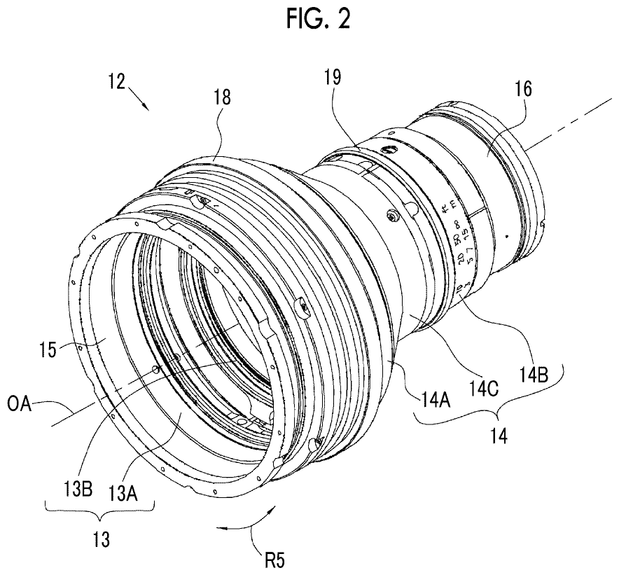

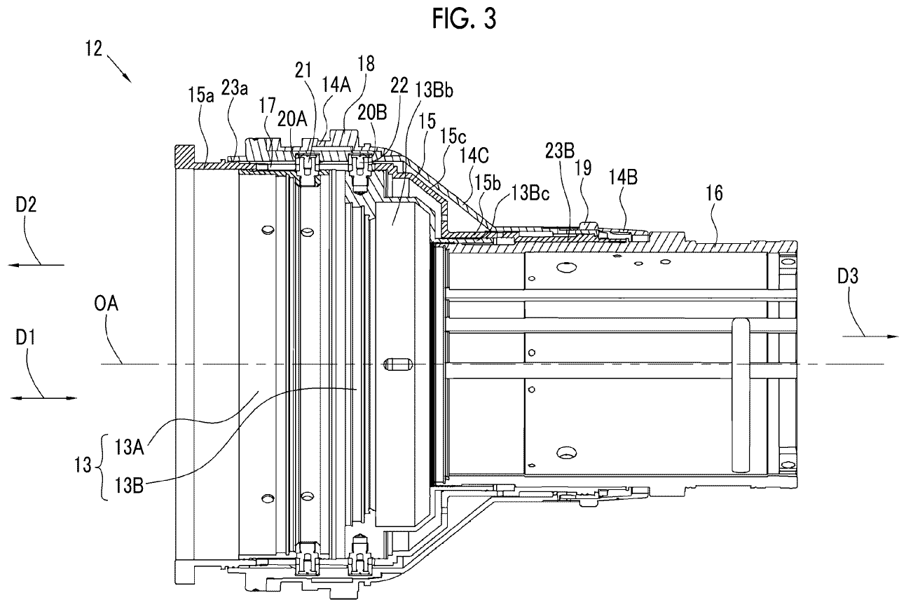

As shown in FIGS. 2 and 3, the lens device 12 includes a lens portion 13, an operation ring 14, and a fixing member 15. The lens portion 13 is disposed inside the fixing member 15, and the operation ring 14 is disposed outside the fixing member 15.

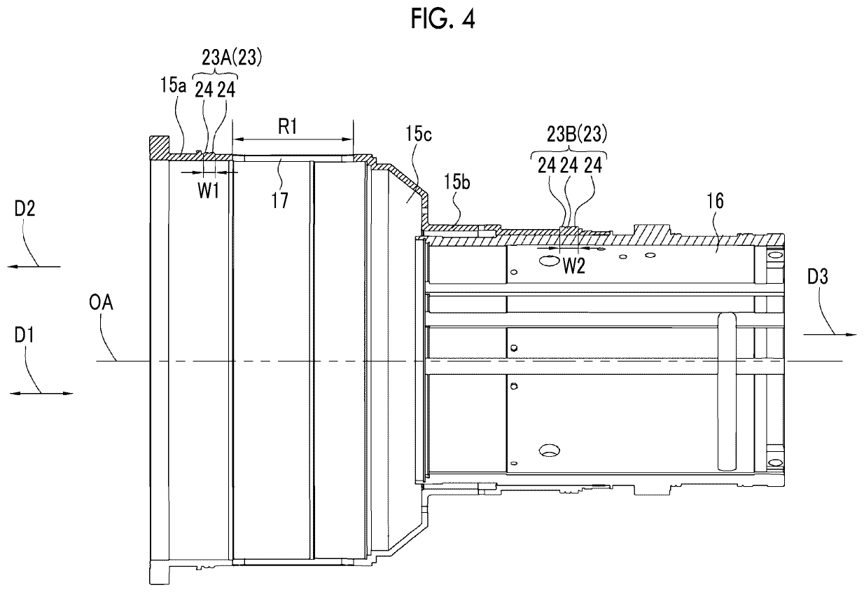

The fixing member 15 is fixed to the lens barrel 16 and supports the movement of the lens portion 13 in an optical axis direction (a direction of an optical axis OA) D1. As shown in FIG. 4, the fixing member 15 includes a large-diameter cylindrical portion 15a, a small-diameter cylindrical portion 15b, and an inclined portion 15c that connects the large-diameter cylindrical portion 15a and the small-diameter cylindrical portion 15b, which are integrally formed. The small-diameter cylindrical portion 15b is fitted into an outer peripheral surface of the lens barrel 16 and is fixed by, for example, screws (not shown).

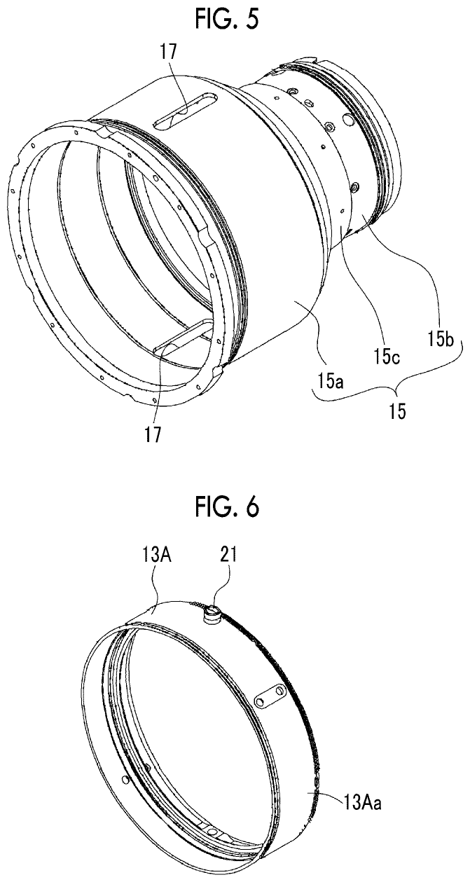

As shown in FIG. 5, the fixing member 15 has a guide groove 17. The guide groove 17 guides the movement of the lens portion 13 by suppressing the rotation of the lens portion 13 with the rotation of the first operation ring 14A and the second operation ring 14B, which will be described later. The guide groove 17 is formed of an elongated hole extending along the optical axis direction D1.

In the present embodiment, the lens portion 13 comprises a first lens portion 13A and a second lens portion 13B. The first lens portion 13A is disposed closer to the subject D2 than the second lens portion 13B.

As shown in FIG. 6, the first lens portion 13A includes a cylindrical first lens holder 13Aa and a lens (not shown) held by the first lens holder 13Aa. The first lens portion 13A is accommodated inside the large-diameter cylindrical portion 15a of the fixing member 15 and is movable in the optical axis direction D1 with respect to the fixing member 15. That is, the first lens portion 13A is guided by the guide groove 17 provided in the fixing member 15 and is movable in the optical axis direction D1. Here, the lens held by the first lens portion 13A is a focus lens.

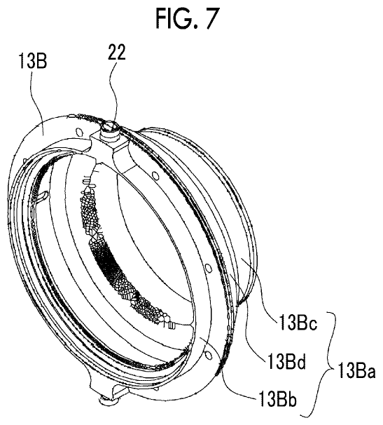

As shown in FIG. 7, the second lens portion 13B includes a second lens holder 13Ba and a lens (not shown) held by the second lens holder 13Ba. The second lens holder 13Ba has a large-diameter cylindrical portion 13Bb, a small-diameter cylindrical portion 13Bc, and an inclined portion 13Bd that connects the large-diameter cylindrical portion 13Bb and the small-diameter cylindrical portion 13Bc, which are integrally formed. The large-diameter cylindrical portion 13Bb is accommodated inside the large-diameter cylindrical portion 15a of the fixing member 15 and is movable in the optical axis direction D1 with respect to the fixing member 15. The small-diameter cylindrical portion 13Bc is disposed between the small-diameter cylindrical portion 15b of the fixing member 15 and the lens barrel 16, and is movable in the optical axis direction D1 with respect to the small-diameter cylindrical portion 15b and the lens barrel 16. That is, the second lens portion 13B is guided by the guide groove 17 provided in the fixing member 15 and is movable in the optical axis direction D1. Here, the lens held by the second lens portion 13B is a focus lens.

The operation ring 14 operates the movement of the lens portion 13. In the present embodiment, the operation ring 14 includes a first operation ring 14A, a second operation ring 14B, and a connecting member 14C. However, instead of configuring the first operation ring 14A, the second operation ring 14B, and the connecting member 14C with separate members, the first operation ring 14A, the second operation ring 14B, and the connecting member 14C may be integrally formed to configure the operation ring 14.

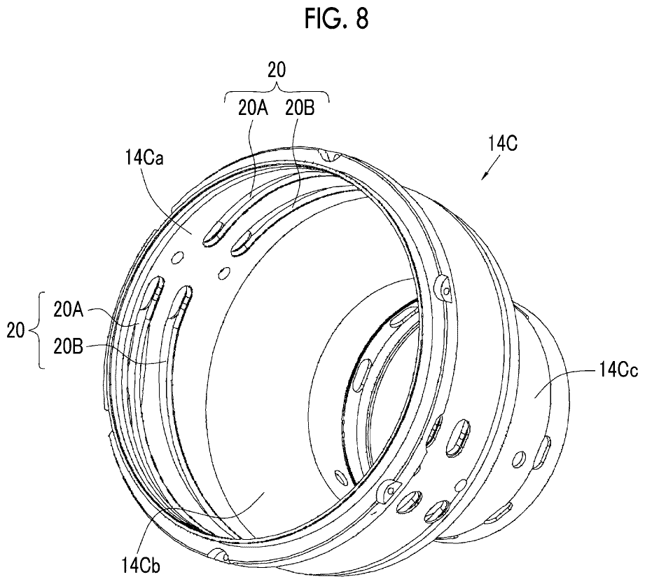

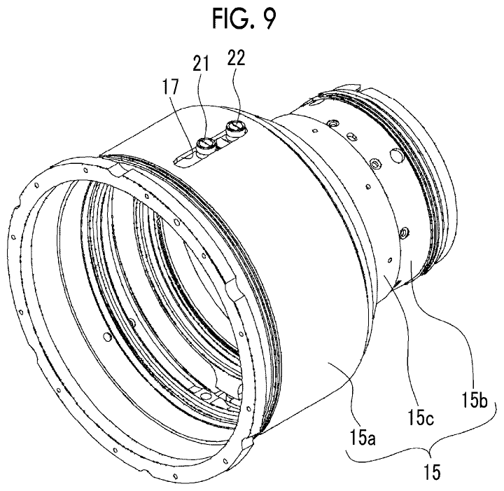

The connecting member 14C connects the first operation ring 14A and the second operation ring 14B to each other and converts the rotation of the first operation ring 14A and the second operation ring 14B into the movement of the lens portion 13 in the optical axis direction D1. As shown in FIGS. 8 and 9, the connecting member 14C has a large-diameter cylindrical portion 14Ca, a small-diameter cylindrical portion 14Cb, and an inclined portion 14Cc that connects the large-diameter cylindrical portion 14Ca and the small-diameter cylindrical portion 14Cb, which are integrally formed. The large-diameter cylindrical portion 14Ca is disposed to cover an outer peripheral surface of the large-diameter cylindrical portion 15a of the fixing member 15. The small-diameter cylindrical portion 14Cb is disposed to cover an outer peripheral surface of the small-diameter cylindrical portion 15b of the fixing member 15.

As shown in FIG. 10, the first operation ring 14A includes a first gear portion 18. The first operation ring 14A has a cylindrical shape. The first operation ring 14A is fitted into the outside of the large-diameter cylindrical portion 14Ca of the connecting member 14C and is fixed by, for example, a screw (not shown). The first gear portion 18 is provided on the outer peripheral surface of the first operation ring 14A over the entire circumference in the circumferential direction.

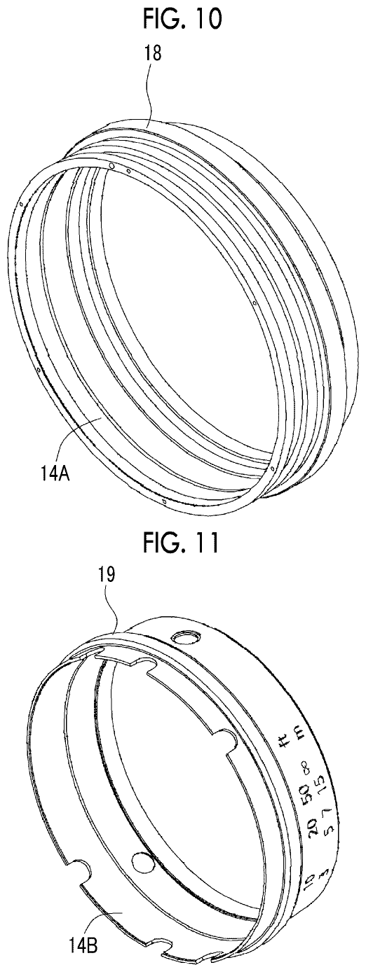

As shown in FIG. 11, the second operation ring 14B includes a second gear portion 19. The second operation ring 14B is fixed to a small-diameter cylindrical portion 14Cb of the connecting member 14C. The second gear portion 19 is provided on the outer peripheral surface of the second operation ring 14B over the entire circumference in the circumferential direction.

The first gear portion 18 is driven by, for example, a driving unit 25 (see FIG. 1) of an external accessory. In addition, the second gear portion 19 is driven by, for example, a drive unit 26 (see FIG. 1) of the camera 10. The second gear portion 19 is set to be smaller than the first gear portion 18, and the camera 10 on which the drive unit 26 is mounted is reduced in size. On the other hand, since the predetermined size is ensured as the first gear portion 18, the driving unit 25 of the external accessory, which is a general-purpose product, can be used. Therefore, the first module of the first gear portion 18 and the second module of the second gear portion 19 have different sizes. More specifically, the first module is set to be larger than the second module. In this way, by making the first module of the first gear portion 18 different from the second module of the second gear portion 19, the corresponding range of the external accessory can be widened. The second module is set to be smaller than the first module, and the digital camera 10 on which the drive unit 26 is mounted is reduced in size. On the other hand, since the first module has a predetermined size, the driving unit 25 of the external accessory, which is a general-purpose product, can be used.

As shown in FIG. 8, the operation ring 14 moves the lens portion 13 in the optical axis direction DI in a cam type. Therefore, the operation ring 14 is provided with a cam groove 20 for operating the movement of the lens portion 13. The cam groove 20 is provided on an inner peripheral surface of a large-diameter cylindrical portion 14Ca of the connecting member 14C of the operation ring 14. In the present embodiment, since the lens portion 13 comprises the first lens portion 13A and the second lens portion 13B, the first cam groove 20A that operates the movement of the first lens portion 13A in the optical axis direction D1 and the second cam groove 20B that operates the movement of the second lens portion 13B in the optical axis direction D1 are provided as the cam grooves 20. The first cam groove 20A and the second cam groove 20B are provided in a spiral shape on the inner peripheral surface of the large-diameter cylindrical portion 14Ca.

The first cam groove 20A is provided at a position facing the guide groove 17 of the fixing member 15 and facing the first lens holder 13Aa of the first lens portion 13. In response to the first cam groove 20A, the first cam follower portion 21 is provided on the first lens holder 13Aa of the first lens portion 13. The first cam follower portion 21 passes through the guide groove 17 of the fixing member 15 and is inserted into the first cam groove 20A of the operation ring 14.

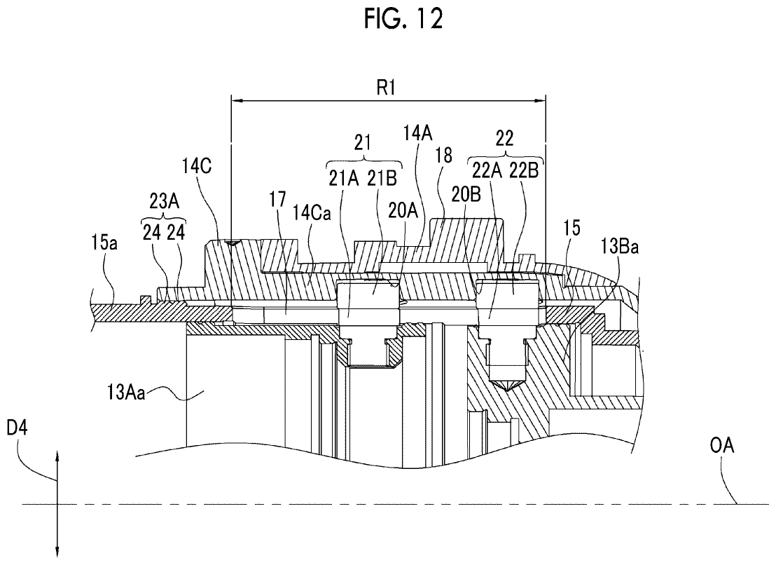

As shown in FIG. 12, the first cam follower portion 21 comprises two cam followers 21A and 21B. The first cam follower 21A faces the fixing member 15 and is guided in the guide groove 17 to move in the guide groove 17, that is, to move in the optical axis direction D1. The second cam follower 21B is inserted into the first cam groove 20A of the operation ring 14 and is guided by the first cam groove 20A to move in the first cam groove 20A. That is, the first cam follower portion 21 moves while being guided by the spiral first cam groove 20A with the rotation of the operation ring 14, but the movement of the first cam follower portion 21 is suppressed or limited in the optical axis direction D1 by the guide groove 17. As a result, the first cam follower portion 21 moves in the optical axis direction D1 with the rotation of the operation ring 14. Therefore, the first lens holder 13Aa provided with the first cam follower portion 21 is also moved in the optical axis direction DI with the rotation of the operation ring 14.

The second cam groove 20B is provided at a position facing the guide groove 17 of the fixing member 15 and facing the large-diameter cylindrical portion 13Bb of the second lens holder 13Ba of the second lens portion 13B. In response to the second cam groove 20B, the second cam follower portion 22 is provided on the large-diameter cylindrical portion 13Bb of the second lens holder 13Ba of the second lens portion 13B. The second cam follower portion 22 passes through the guide groove 17 of the fixing member 15 and is inserted into the second cam groove 20B of the operation ring 14.

The second cam follower portion 22 comprises two cam followers 22A and 22B. The first cam follower 22A faces the fixing member 15 and is guided by the guide groove 17 to move in the optical axis direction D1. The second cam follower 22B is inserted into the second cam groove 20B of the operation ring 14 and is guided by the second cam groove 20B to move in the second cam groove 20B. That is, the second cam follower portion 22 moves while being guided by the spiral cam groove 20 with the rotation of the operation ring 14, but the movement of the second cam follower portion 22 is suppressed or limited in the optical axis direction D1 by the guide groove 17. As a result, the second cam follower portion 22 moves in the optical axis direction D1 with the rotation of the operation ring 14. Therefore, the second lens holder 13Ba provided with the second cam follower portion 22 is also moved in the optical axis direction D1 with the rotation of the operation ring 14.

In addition, as shown in FIG. 12, the first gear portion 18 is disposed inside the guide groove 17 (a range indicated by a reference numeral R1) as viewed in the direction D4 intersecting the optical axis OA, in other words, in a region facing the guide groove 17. In FIG. 12 and the like, a case as viewed in the direction D4 intersecting the optical axis OA is shown as being orthogonal to the optical axis OA, but the case is not limited to the direction orthogonal to the optical axis OA, and any direction intersecting the optical axis OA is included. The first cam follower portion 21 and the second cam follower portion 22 pass through the guide groove 17 and are inevitably disposed inside the guide groove 17. Therefore, the first cam groove 20A into which the first cam follower portion 21 is inserted and the second cam groove 20B into which the second cam follower portion 22 is inserted are also disposed inside the guide groove 17. It is preferable that the members forming the two cam grooves 20A and 20B are thick. On the other hand, the first gear portion 18 is driven by the driving unit 25 of the external accessory, which is a general-purpose product, and needs to ensure a predetermined size. Therefore, it is relatively easy to make the thickness of the large-diameter cylindrical portion 14Ca of the connecting member 14C into which the first operation ring 14A is fitted and the first operation ring 14A provided with the first gear portion 18 is provided thick to some extent. Therefore, by disposing the first gear portion 18 inside the guide groove 17, the formation of the cam grooves 20A and 20B in the large-diameter cylindrical portion 14Ca of the connecting member 14C is facilitated in design, and the design of the lens device 12 is facilitated.

In addition, since the first operation ring 14A and the second operation ring 14B are connected to each other by the connecting member 14C, the first operation ring 14A, the second operation ring 14B, and the connecting member 14C are integrally rotated as the operation ring 14. The operation ring 14 is disposed on an outer periphery of the fixing member 15, and the operation ring 14 is rotatable with respect to the fixing member 15. That is, the fixing member 15 and the operation ring 14 can be relatively moved (rotated in a direction indicated by an arrow R5 in FIG. 2) while sliding on each other.

Therefore, as shown in FIG. 4, the sliding portion 23 is provided on at least one of the fixing member 15 or the operation ring 14. In the present embodiment, the sliding portion 23 is provided on the outer peripheral surface side of the fixing member 15 over the entire circumference in the circumferential direction. The sliding portion 23 includes a first sliding portion 23A and a second sliding portion 23B. The first sliding portion 23 A is provided on the first operation ring 14A side, and the second sliding portion 23B is provided on the second operation ring 14B side.

The convex portion 24 is formed over the entire circumference of each of the sliding portions 23A and 23B, and the sliding portions 23A and 23B are configured to slide on the convex portion 24 in a case where the fixing member 15 and the operation ring 14 are relatively moved (rotated) while sliding on each other. In the present embodiment, the two rows or three rows of the convex portions 24 are formed on the sliding portions 23A and 23B arranged in the optical axis direction D1, but the number of rows of the convex portions 24 is not limited to two rows or three rows, and may be one row or four or more rows. In addition, the sliding portion 23 may be provided on the inner peripheral surface of the operation ring 14, or the sliding portion 23 may be provided on both the outer peripheral surface of the fixing member 15 and the inner peripheral surface of the operation ring 14. In addition, in a case where the sliding portion 23 is provided on the operation ring 14, the sliding portion 23 may be provided on the connecting member 14C, the first operation ring 14A, or the second operation ring 14B.

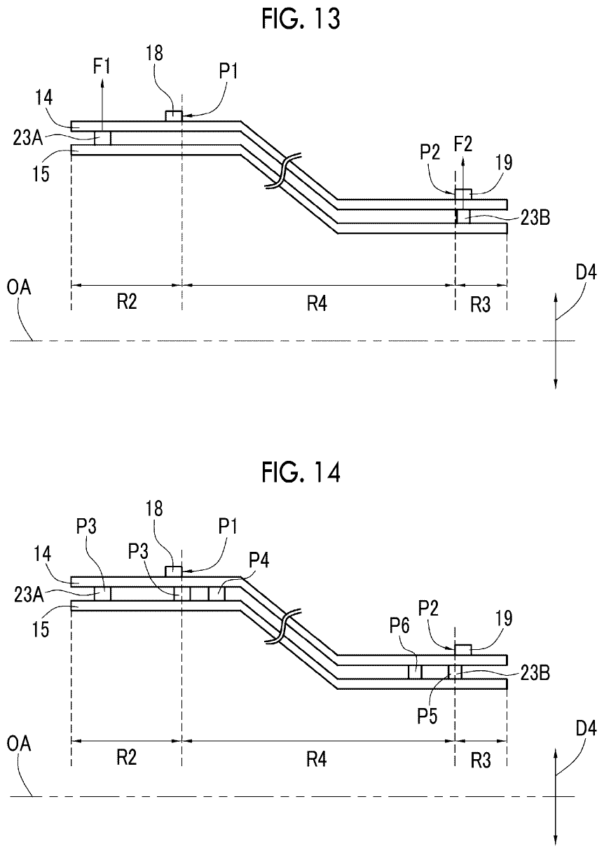

As shown in FIG. 13, specifically, as viewed in the direction D4 intersecting the optical axis OA of the lens portion 13, the first sliding portion 23A is disposed in a region R2 from a position facing the first gear portion 18 toward the subject side D2 on the first operation ring 14A side. In addition, as viewed in the direction D4 intersecting the optical axis OA of the lens portion 13, the second sliding portion 23B is disposed in a region R3 from a position facing the second gear portion 19 on the second operation ring 14B side toward the image forming side D3.

Since the first sliding portion 23A and the second sliding portion 23B are disposed as described above, the first reaction force F1 in the first sliding portion 23A and the second reaction force F2 in the second sliding portion 23B, which are generated in a case where an external force is applied to at least any one of the first gear portion 18 or the second gear portion 19, are substantially in the same direction. Here, “substantially in the same direction” also includes a case where the direction of the first reaction force F1 and the direction of the second reaction force F2 are different from each other within a range in which the occurrence of a moment described later is suppressed to a degree that there is no adverse effect, in addition to a case where the direction of the first reaction force F1 and the direction of the second reaction force F2 are the same.

Here, the positional relationship between the gear portions 18 and 19 and the sliding portions 23A and 23B is specifically as follows. As viewed in the direction D4 intersecting the optical axis OA of the lens portion 13, the first sliding portion 23A is disposed at a position closer to the subject side D2 than the first gear portion 18 or at a position that partially overlaps with the first gear portion 18. In addition, as viewed in the direction D4 intersecting the optical axis OA of the lens portion 13, the second sliding portion 23B is disposed at a position closer to the image forming side D3 than the second gear portion 19 or at a position that partially overlaps with the second gear portion 19. In other words, as shown in FIG. 14, the sliding portions 23A and 23B are disposed outside a region R4 between the end P1 of the first gear portion 18 on the image forming side D3 and the end P2 of the second gear portion 19 on the subject side D2, as a whole or a part thereof. In the present embodiment, as viewed in the direction D4 intersecting the optical axis OA of the lens portion 13, the first sliding portion 23A is positioned closer to the subject side D2 than the first gear portion 18, and the second sliding portion 23B is disposed at a position overlapping the second gear portion 19.

For example, the first sliding portion 23A can be disposed at a position shown at P3 in FIG. 14 (a position closer to the subject side D2 than the first gear portion 18 or a position that partially overlaps the first gear portion 18), but is not appropriate at a position shown at P4 (a position that does not overlap the first gear portion 18 at all). In addition, the second sliding portion 23B can be disposed at a position shown in P5 of FIG. 14 (a position on the image forming side D3 with respect to the second gear portion 19 or a position that partially overlaps the second gear portion 19), but is not appropriate at a position shown in P6 (a position that does not overlap the second gear portion 19 at all).

With such the disposition, an external force acting on the first gear portion 18 or the second gear portion 19 is directly transmitted to the first sliding portion 23A or the second sliding portion 23B, and as a reaction force, reaction forces F1 and F2 smaller than the external force acting on the first sliding portion 23A or the second sliding portion 23B and directed in the same direction as the external force are generated. That is, the fixing member 15 can directly receive the operation ring 14, and the generation of a moment in the fixing member 15 and the operation ring 14 can be suppressed. Therefore, it is possible to prevent the sliding portion 23 from being subjected to an extra force, for example, a force greater than an external force acting on any one of the first sliding portion 23A or the second sliding portion 23B, and it is possible to improve the operability in a case where the user operates the operation ring 14.

In the present embodiment, the first sliding portion 23A is disposed closer to the subject side D2 than the first gear portion 18 as viewed in the direction D4 intersecting the optical axis OA of the lens portion 13. In addition, the second sliding portion 23B is disposed to have an overlapping region with the second gear portion 19 as viewed in the direction view D4 intersecting the optical axis OA of the lens portion 13. With such the disposition, as described above, it is possible to further improve the operability in a case where the user operates the operation ring 14.

In addition, as shown in FIG. 4, in the present embodiment, the first sliding portion 23A has a smaller width (a length in the optical axis direction D1) than the second sliding portion 23B. In this manner, the area of the sliding surface of the first sliding portion 23A and the area of the sliding surface of the second sliding portion 23B can be substantially aligned with each other. That is, the large-diameter cylindrical portion 15a of the fixing member 15 provided with the first sliding portion 23A has a larger diameter than the small-diameter cylindrical portion 15b of the fixing member 15 provided with the second sliding portion 23B, and the length of the first sliding portion 23A (the length of the large-diameter cylindrical portion 15a in the circumferential direction) is longer than the length of the second sliding portion 23B (the length of the small-diameter cylindrical portion 15b in the circumferential direction). Therefore, in a case where the width W1 of the first sliding portion 23A and the width W2 of the second sliding portion 23B are aligned with each other, the area of the sliding surface of the first sliding portion 23A and the area of the sliding surface of the second sliding portion 23B cannot be aligned with each other (area=length×width). Therefore, the width W1 of the first sliding portion 23A is made smaller than the width W2 of the second sliding portion 23B, and the area of the sliding surface of the first sliding portion 23A and the area of the sliding surface of the second sliding portion 23B are substantially aligned with each other.

In a case where the operation ring 14 is operated, a rotational resistance force is generated as a frictional force in the first sliding portion 23A and the second sliding portion 23B. By aligning the area of the sliding surface of the first sliding portion 23A and the area of the sliding surface of the second sliding portion 23B, the pressure acting on the first sliding portion 23A and the pressure acting on the second sliding portion 23B during the operation of the operation ring 14 can be aligned, and the operability in a case where the user operates the operation ring 14 can be further improved.

### Operation of Lens Device

In a case where the first gear portion 18 is rotated by the driving unit 25 of the external accessory or the second gear portion 19 is rotated by the drive unit 26, the operation ring 14 is rotated with respect to the fixing member 15. In a case where the operation ring 14 is rotated, the cam follower portions 21 and 22 are guided to the spiral cam grooves 20A and 20B and are moved. Since the cam follower portions 21 and 22 pass through the guide grooves 17 and can be moved only in the optical axis direction D1, the cam follower portions 21 and 22 are moved in the optical axis direction DI with the rotation of the operation ring 14. Since the first cam follower portion 21 is provided on the first lens holder 13Aa of the first lens portion 13A and the second cam follower portion 22 is provided on the second lens holder 13Ba of the second lens portion 13B, the first lens portion 13A and the second lens portion 13B are moved in the optical axis direction D1 by the rotation of the operation ring 14.

Since the operation ring 14 and the fixing member 15 slide on the convex portion 24 of the sliding portion 23, it is possible to prevent the operation ring 14 and the fixing member 15 from sliding at a position other than the sliding portion 23. Therefore, the operation ring 14 and the fixing member 15 can be slid at a specific position that is predetermined at the time of design, and in other words, the sliding position can be accurately controlled.

In the above-described embodiment, although an example in which the lens portion 13 is moved in the optical axis direction D1 in a cam type is described, the lens portion 13 may be moved in the optical axis direction DI by a so-called helicoid screw type. In this case, the lens device can be manufactured at a lower cost than the cam type. In addition to the cam type and the helicoid screw type, the lens portion 13 may be moved in the optical axis direction D1 by a separate member (a cam part, a helicoid part, or the like) that rotates in conjunction with the operation ring 14.

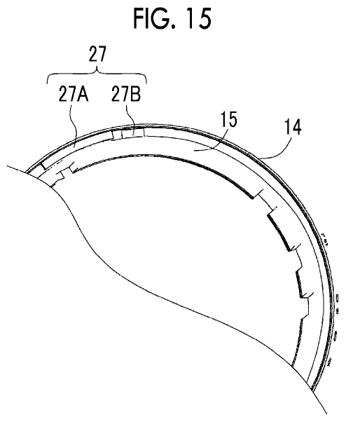

In addition, an angle restricting member that restricts the rotation range of the operation ring 14 with respect to the fixing member 15 may be provided. Specifically, as shown in FIG. 15, the angle restricting member 27 comprises an operation ring side member 27A and a fixed side member 27B. The operation ring side member 27A is fixed and disposed on an inner side surface of the second operation ring 14B of the operation ring 14. The fixed side member 27B is positioned on a movement orbit of the second operation ring 14B and is fixed and disposed on the outer peripheral surface of the fixing member 15. The angle restricting member 27 can restrict the rotation range of the operation ring 14 with respect to the fixing member 15, and as a result, the movement range of the lens portion 13 in the optical axis direction DI can be restricted. In addition, information, such as a focusing distance, may be described in the angle restricting member 27, for example, the operation ring side member 27A. In this way, the rotation range of the operation ring 14 with respect to the fixing member 15 can be seen at a glance. In addition, the angle restricting member may be provided in a gear component that is interlocked with the rotation of the operation ring 14.

In addition, the gear portions 18 and 19 may be configured with members separate from the operation rings 14A and 14B, and the gear portions 18 and 19 may be fixed and installed on the operation rings 14A and 14B by a fixing unit such as a screw, tape, or an adhesive. Accordingly, the gear portions 18 and 19 can be easily assembled to the operation rings 14A and 14B.

The lens device according to the embodiment of the present invention can be applied to a lens device such as a TV camera or a digital camera.

### EXPLANATION OF REFERENCES

10: camera
11: camera body
12: lens device
13: lens portion
13A: first lens portion
13Aa: first lens holder
13B: second lens portion
13Ba: second lens holder
13Bb: large-diameter cylindrical portion
13Bc: small-diameter cylindrical portion
13Bd: inclined portion
14: operation ring
14A: first operation ring
14B: second operation ring
14C: connecting member
14Ca: large-diameter cylindrical portion
14Cb: small-diameter cylindrical portion
14Cc: inclined portion
15: fixing member
15a: large-diameter cylindrical portion
15b: small-diameter cylindrical portion
15c: inclined portion
16: lens barrel
17: guide groove
18: first gear portion
19: second gear portion
20: cam groove
20A: first cam groove
20B: second cam groove
21: first cam follower portion
21A: first cam follower
21B: second cam follower
22: second cam follower portion
22A: first cam follower
22B: second cam follower
23: sliding portion
23A: first sliding portion
23B: second sliding portion
24: convex portion
25: driving unit of external accessory
26: drive unit
27: angle restricting member
27A: operation ring side member
27B: fixed side member

What is claimed is:

1. A lens device comprising:
a lens portion;
an operation ring that has a first gear portion and a second gear portion and that operates movement of the lens portion; and
a fixing member that is fixed to a lens barrel and that supports movement of the lens portion in an optical axis direction, the fixing member and the operation ring being relatively moved while sliding on each other by a sliding portion,
wherein the sliding portion includes a convex portion formed on at least any one of the fixing member or the operation ring.

2. The lens device according to claim 1,
wherein the operation ring includes a first operation ring that has the first gear portion, a second operation ring that has the second gear portion, and a connecting member that connects the first operation ring and the second operation ring and converts rotations of the first operation ring and the second operation ring into the movement of the lens portion in the optical axis direction, and
the sliding portion slides on the convex portion formed on at least any one of the fixing member or the connecting member.

3. The lens device according to claim 1,
wherein the fixing member includes a guide groove that guides the movement of the lens portion by suppressing rotation of the lens portion with rotation of the operation ring.

4. The lens device according to claim 1,
wherein the sliding portion includes a first sliding portion and a second sliding portion,
as viewed in a direction intersecting an optical axis of the lens portion,
the first sliding portion is disposed in a region from a position facing the first gear portion toward a subject side, and
the second sliding portion is disposed in a region from a position facing the second gear portion toward an image forming side.

5. The lens device according to claim 1,
wherein the sliding portion includes a first sliding portion and a second sliding portion, and
the first sliding portion and the second sliding portion are disposed such that a first reaction force in the first sliding portion and a second reaction force in the second sliding portion, which are generated in a case where an external force is applied to at least any one of the first gear portion or the second gear portion, are in the same direction.

6. The lens device according to claim 4,
wherein, as viewed in the direction intersecting the optical axis of the lens portion,
the first sliding portion is disposed closer to the subject side than the first gear portion, and
the second sliding portion is disposed to have an overlapping region with the second gear portion.

7. The lens device according to claim 1,
wherein a first module of the first gear portion and a second module of the second gear portion have different sizes.

8. The lens device according to claim 7,
wherein the first module is larger than the second module.

9. The lens device according to claim 3,
wherein, as viewed in a direction intersecting an optical axis,
the first gear portion is disposed inside the guide groove.

10. The lens device according to claim 4,
wherein the first gear portion and the second gear portion are formed in a circumferential direction of the operation ring,
the first gear portion has a larger diameter than the second gear portion, and
the first sliding portion has a smaller width than the second sliding portion.
